(19) United States
(12) Patent Application Publication
(10) Pub. No.: US 2025/0243430 A1
(43) Pub. Date: Jul. 31, 2025

(54) ENZYMATIC, HIGH PH DETERGENT COMPOSITION WITH AMINO ACIDS

(71) Applicant: Henkel AG & Co. KGaA, Duesseldorf (DE)

(72) Inventor: Daniel Thomas PIORKOWSKI, Fairfield, CT (US)

(73) Assignee: Henkel AG & Co. KGaA, Duesseldorf (DE)

(21) Appl. No.: 18/425,876

(22) Filed: Jan. 29, 2024

(51) Int. Cl. C11D 1/831; C11D 1/12; C11D 1/72; C11D 3/00; C11D 3/04; C11D 3/10; C11D 3/28; C11D 3/30; C11D 3/33; C11D 3/37; C11D 3/386

(52) U.S. Cl. CPC C11D 1/831; C11D 1/12; C11D 1/72; C11D 3/0036; C11D 3/0047; C11D 3/044; C11D 3/10; C11D 3/28; C11D 3/30; C11D 3/33; C11D 3/3765; C11D 3/38618; C11D 3/38636; C11D 2111/12

(57) ABSTRACT

The present disclosure provides a detergent composition comprising water, at least one surfactant, at least one amino acid or a salt thereof, such as lysine or arginine, and at least one enzyme. The detergent composition has a pH of about 10 to about 12. The detergent composition can further comprise additional components, such base, a performance polymer, an anti-redeposition agent, a defoamer, a chelating agent, a biocide, and any combination thereof. Due to the presence of the amino acid, the detergent composition can scavenge chlorine to a concentration of 0 ppm in less than about 120 sec after contact with a 1 L water sample comprising up to 4 ppm chlorine.

### BACKGROUND

Municipal water originates from a variety of sources, such as lakes, rivers, reservoirs, and wells. To make the water drinkable, chlorine can be added as a disinfectant. A concentration up to 4 ppm chlorine is typically the maximum allowed in municipal water, as suggested by the Centers for Disease Control and Prevention.

However, chlorine is known to deteriorate a fabric's dye over time, particularly red, blue, or black dyes. If not controlled, this dye deterioration generally will be seen in about 3 to 30 washes. In addition to fabric dye damage, chlorine in the water can negatively impact an enzyme's performance for cleaning soiled laundry. Monoethanolamine can be used in a detergent composition as a pH buffer and a chlorine scavenger. Triethanolamine can be added as a pH buffer. However, these amines are not yet certified as Safer Choice labeling designation by the U.S. Environmental Protection Agency (EPA).

Since there is a consumer push for improving detergent sustainability, there is a need for a detergent composition that can effectively clean textiles while scavenging chlorine to protect fabric dyes and enzyme activity by incorporating more Safer Choice ingredients.

### BRIEF SUMMARY

The present disclosure relates to a detergent composition comprising water, at least one surfactant, at least one amino acid or a salt thereof, and at least one enzyme, wherein the detergent composition has a pH of about 10 to about 12.

In some aspects, the at least one amino acid is selected from alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, any salt thereof, and any combination thereof. In some aspects, wherein the at least one amino acid has a charged side chain or a polar uncharged side chain. In some aspects, the at least one amino acid is lysine, threonine, arginine, any salt thereof, or any combination thereof including salts thereof.

In some aspects, the at least one surfactant is an anionic surfactant, a cationic surfactant, a zwitterionic surfactant, a nonionic surfactant, or any combination thereof. In some aspects, the anionic surfactant comprises an alkyl sulfate, an alkyl sulfonate, a fatty acid salt, a bile acid salt, a glutamic acid salt, a cholic acid salt, a carboxylic poly(ethylene glycol) ether, a taurate, or any combination thereof. In some aspects, the cationic surfactant comprises a fatty amine salt, a fatty diamine salt, a coco amine alkoxylate, an alkoxylated amine, an alkoxylated diamine, fatty quaternary ammonium compound, a fatty amide quaternary ammonium compound, an alkoxylated quaternary ammonium compound, a benzalkyl quaternary ammonium compound, or any combination thereof. In some aspects, the zwitterionic surfactant comprises a betaine, a sulfonated quaternary ammonium compound, a phosphonated quaternary ammonium compound, a trialkylamine N-oxide, or any combination thereof. In some aspects, the nonionic surfactant comprises an alcohol alkoxylate, a fatty acid alkoxylate, an alkyl phenol ethoxylate, an alkoxylated amine, an alkyl glucoside, a fatty amide alkoxylate, a diester of alkoxylated fatty acid, an alkoxylated methyl ester of fatty acid, a glycerol fatty ester, castor oil alkoxylate, an ethylene oxide-propylene oxide block copolymer, a phenol alkoxylate, or any combination thereof.

In some aspects, the detergent composition comprises an alcohol ethoxylate, an alkylether sulfate, a coconut fatty acid, or any combination thereof.

In some aspects, the at least one enzyme comprises a protease, an amylase, a mannanase, a lactase, a lipase, a perhydrolase, an oxidoreductase, an endocellulase, an exocellulase, or any combination thereof. In some aspects, the at least one enzyme comprises a protease, an amylase, a mannanase, or any combination thereof.

In some aspects, the detergent composition has a pH of about 10.5 to about 11.

In some aspects, the detergent composition further comprises a base. In some aspects, the base is a hydroxide, a tetraborate, a phosphate, a carbonate, a bicarbonate, or any combination thereof.

In some aspects, the detergent composition further comprises at least one additive selected from a performance polymer, an anti-redeposition agent, a defoamer, a chelating agent, a biocide, and any combination thereof. In some aspects, the detergent composition further comprises a performance polymer that is polyethyleneimine ethoxylate, polyethyleneimine ethoxylate propoxylate, or a combination of both.

In some aspects, the detergent composition further comprises an anti-redeposition agent based on acrylic acid.

In some aspects, the detergent composition comprises about 55 to about 75 wt % water, about 15 to about 30 wt % of at least one surfactant (e.g., at least one anionic surfactant, and/or at least one nonionic surfactant), about 0.25 to about 2 wt % of at least one amino acid or a salt thereof, and about 0.05 to about 3 wt % of at least one enzyme.

In some aspects of this composition, the detergent composition comprises a base, a biocide, a performance polymer, an antiredeposition agent, and a chelating agent.

In some aspects of this composition, the detergent composition comprises about 55 to about 75 wt % water, about 15 to about 30 wt % of at least one surfactant selected from an alkylether sulfate, an alcohol ethoxylate, and coconut fatty acid, about 0.25 to about 2 wt % of at least one amino acid selected from lysine, arginine, or a salt thereof, about 0.05 to about 3 wt % of at least one enzyme, and a base comprising a hydroxide and a carbonate.

In some aspects, the detergent composition described herein scavenges chlorine to a concentration of 0 ppm in less than about 120 sec after contact with a 1 L water sample comprising up to 4 ppm chlorine.

### DETAILED DESCRIPTION

Provided herein is a detergent composition comprising water, at least one surfactant, at least one amino acid or a salt thereof, and at least one enzyme, wherein the detergent composition has a pH of about 10 to about 12.

Non-limiting examples of the various aspects are shown in the present disclosure.

### Definitions

In order that the present disclosure can be more readily understood, certain terms are first defined. Additional definitions are set forth throughout the detailed disclosure.

All of the various aspects, embodiments, and options disclosed herein can be combined in any and all variants unless otherwise specified. Terms in this application control in the event of a conflict with a patent or publication term that is incorporated by reference.

As used herein, “a,” “an,” or “the” means one or more unless otherwise specified.

Furthermore, “and/or,” where used herein, is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

Open terms such as “include,” “including,” “contain,” “containing” and the like mean “comprising.” The term “or” can be conjunctive or disjunctive.

It is understood that wherever aspects are described herein with the language “comprising,” otherwise analogous aspects described in terms of “consisting of” and/or “consisting essentially of” are also provided.

Some inventive embodiments contemplate numerical ranges. Every numerical range provided herein includes the range endpoints as individual inventive embodiments. When a numerical range is provided, all individual values and sub-ranges therein are present as if explicitly written out.

The term “about” includes the recited number+10%. For example, “about 10” means 9 to 11.

The phrase “substantially free of” means that a composition contains little to none of specified ingredient/component, such as less than about 5 wt %, less than about 4 wt %, less than about 3 wt %, less than about 2 wt %, less than about 1 wt %, less than about 0.5 wt %, less than about 0.3 wt %, less than about 0.2 wt %, less than about 0.1 wt %, or about 0 wt % of the specified ingredient.

As used herein, the “%” described in the present application refers to the weight percentage unless otherwise indicated.

The term “at least” prior to a number or series of numbers is understood to include the number adjacent to the term “at least,” and all subsequent numbers or integers that could logically be included, as clear from context. For example, “at least one enzyme” means that 1, 2, 3, or more enzymes are included in the detergent composition. When at least is present before a series of numbers or a range, it is understood that “at least” can modify each of the numbers in the series or range. “At least” is also not limited to integers (e.g., “at least 5%” includes 5.0%, 5.1%, 5.18% without consideration of the number of significant FIGURES).

Unless states otherwise, the term “by weight of the composition” refers to a composition of a final product derived from a process, unless otherwise defined.

The terms “process” and “method” can be used interchangeably.

The terms “alkoxylate” or “alkoxylated” as used in the present application means: the presence of an polyaliphatic ether moiety in a compound, such as ethoxylate (—CH₂CH₂O—) or propoxylate (—CH(CH₃)CH₂O—). A polyethoxylate is multiple repeat units of ethoxylate ((—CH₂CH₂O—)ⁿ), and a polypropoxylate is multiple repeat units of propoxylate ((—CH(CH₃)CH₂O—)ₘ). The subscripts “n” and “m” are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

The terms “ethoxylate” or “ethoxylated” as used in the present application means the presence of multiple repeat units of ethoxylate ((—CH₂CH₂O—)ⁿ). The subscript “n” is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

### Detergent Composition

In some aspects, the present disclosure is directed to a detergent composition comprising water, at least one surfactant, at least one amino acid or a salt thereof, and at least one enzyme, wherein the detergent composition has a pH of about 10 to about 12.

The present disclosure is predicated on the discovery that an amino acid can be used in a detergent (e.g., liquid detergent) as a chlorine scavenger and, in some circumstances, a pH buffer. As an added benefit, the use of an amino acid is environmentally friendly, helping to provide a Safer Choice labeling designation by the U.S. EPA.

The detergent composition comprises at least one (e.g., 1, 2, 3, 4, 5, or 6, etc.) amino acid to act as a chlorine scavenger. In some aspects, the at least one amino acid further acts as a pH buffer. In some aspects, the at least one amino acid is a naturally occurring amino acid, including one of the 20 naturally occurring amino acids (e.g., alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, any salt thereof, or any combination thereof). In some aspects, the amino acid has a charged side chain (e.g., arginine, aspartic acid, glutamic acid, histidine, or lysine). In some aspects, the at least one amino acid has a polar uncharged side chain (e.g., serine, threonine, asparagine, or glutamine). In the aspects, the at least one amino acid has a hydrophobic side chain (e.g., alanine, valine, isoleucine, leucine, methionine, phenylalanine, tyrosine, or tryptophan). In some aspects, the at least one amino acid is cysteine, glycine, or proline. In some aspects, the at least one amino acid has a charged side chain or a polar uncharged side chain. In some aspects, the at least one amino acid is in the form of a salt, e.g., lysine hydrochloride.

In some aspects, the detergent composition comprises one or two amino acids, but in some aspects, the detergent composition comprises one amino acid. In some aspects, the at least one amino acid is lysine, threonine, arginine, any salt thereof, or any combination including salts thereof. In some aspects, the detergent composition comprises lysine or a salt thereof (e.g., lysine hydrochloride). In some aspects, the detergent composition comprises arginine.

In some aspects, the detergent composition comprises from about 0.001 wt % to about 5 wt % of total amount of at least one amino acid (e.g., lysine, arginine, threonine, any salt thereof, or any combination) relative to the total weight of the detergent composition. For example, the total amino acid content can be from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the detergent composition. In some aspects, the detergent composition comprises about 0.25 to about 2 wt % of at least one amino acid or a salt thereof (e.g., lysine, arginine, threonine, any salt thereof, or any combination). In some aspects, the detergent composition comprises about 0.5 to about 1 wt % of at least one amino acid or a salt thereof (e.g., lysine, arginine, threonine, any salt thereof, or any combination). In some aspects, the detergent composition comprises about 0.5 wt % or about 1 wt % of at least one amino acid or a salt thereof (e.g., lysine, arginine, threonine, any salt thereof, or any combination).

The detergent composition comprises water as a solvent. In some aspects, the detergent composition comprises from about 50 wt % to about 80 wt % of water relative to the total weight of the detergent composition. For example, the water content can be present in an amount from about 50 wt % to about 75 wt %, about 50 wt % to about 70 wt %, about 50 wt % to about 65 wt %, about 50 wt % to about 60 wt %, about 50 wt % to about 55 wt %, about 52 wt % to about 80 wt %, about 52 wt % to about 75 wt %, about 52 wt % to about 70 wt %, about 52 wt % to about 65 wt %, about 52 wt % to about 60 wt %, about 52 wt % to about 55 wt %, about 55 wt % to about 80 wt %, about 55 wt % to about 75 wt %, about 55 wt % to about 70 wt %, about 55 wt % to about 65 wt %, about 55 wt % to about 60 wt %, about 60 wt % to about 80 wt %, about 60 wt % to about 75 wt %, about 60 wt % to about 70 wt %, about 60 wt % to about 65 wt %, about 62 wt % to about 80 wt %, about 62 wt % to about 75 wt %, about 62 wt % to about 70 wt %, about 62 wt % to about 65 wt %, about 65 wt % to about 80 wt %, about 65 wt % to about 75 wt %, about 65 wt % to about 70 wt %, about 68 wt % to about 80 wt %, about 68 wt % to about 75 wt %, about 68 wt % to about 70 wt %, about 70 wt % to about 80 wt %, about 70 wt % to about 75 wt %, about 70 wt % to about 72 wt %, about 72 wt % to about 80 wt %, about 72 wt % to about 75 wt %, about 75 wt % to about 80 wt %, about 78 wt % to about 80 wt %, about 80 wt %, about 79 wt %, about 78 wt %, about 77 wt %, about 76 wt %, about 75 wt %, about 74 wt %, about 73 wt %, about 72 wt %, about 71 wt %, about 70 wt %, about 69 wt %, about 68 wt %, about 67 wt %, about 66 wt %, about 65 wt %, about 64 wt %, about 63 wt %, about 62 wt %, about 61 wt %, about 60 wt %, about 59 wt %, about 58 wt %, about 57 wt %, about 56 wt %, about 55 wt %, about 54 wt %, about 53 wt %, about 52 wt %, about 51 wt %, or about 50 wt %, of the total weight of the detergent composition. In some aspects, the detergent composition comprises from about 55 wt % to about 75 wt % of water relative to the total weight of the detergent composition. In some aspects, the detergent composition comprises from about 65 wt % to about 75 wt % of water relative to the total weight of the detergent composition. In some aspects, the detergent composition comprises from about 68 wt % to about 72 wt % of water relative to the total weight of the detergent composition.

In some aspects, the at least one (e.g., 1, 2, 3, 4, 5, or 6, etc.) surfactant is an anionic surfactant, a cationic surfactant, a zwitterionic surfactant, a nonionic surfactant, or a combination thereof. In some aspects, the detergent composition comprises a combination of at least one anionic surfactant and at least one nonionic surfactant.

The anionic surfactant comprises a hydrophobic tail group (e.g., a linear aliphatic chain) and an anionic hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl), alkyl, or fluoro (e.g., perfluorinated). The anionic hydrophilic group can be, for example, a sulfate (—OSO₃⁻), sulfonate (—SO₃—), a phosphate (—OPO₃³⁻), a carboxylate (—C(O)O⁻), or the conjugate base of an organic acid. In some aspects, polyethylene glycol repeat units designated as “ether” can be disposed between the hydrophobic tail group (e.g., a fatty group) and hydrophilic head group.

In some aspects, the anionic surfactant comprises an alkyl sulfate, an alkyl sulfonate, a fatty acid salt, a bile acid salt, a glutamic acid salt, a cholic acid salt, a carboxylic poly(ethylene glycol) ether, a taurate, or a combination thereof. Typically, the salt will be a Group I (e.g., lithium, sodium, potassium, etc.), Group II (e.g., magnesium, calcium, etc.), or ammonium salt.

Examples of an alkyl sulfate include, e.g., a fatty sulfate (e.g., octylsulfate, decyl sulfate, lauryl (dodecyl) sulfate, myristyl sulfate), dioctyl sodium sulfosuccinate, and an alkyl ether sulfate (also called an alcohol ethoxysulfate)). Other examples of fatty sulfate include, e.g., 3-sulfopropyl ethoxylate laurylphenyl ether and coco (coconut fatty acid) sulfate. Examples of an alkyl sulfonate include, e.g., a linear alkylbenzene sulfonate (e.g., sodium laurylbenzene sulfonate), a perfluoroalkyl sulfonate (e.g., perfluorooctyl sulfonate, perfluorobutyl sulfonate), and a methyl ester sulfonate. Examples of a fatty acid salt include, e.g., a caprylate, a laurate, a palmitate, a myristate, and a stearate. Other anionic surfactants include a bile acid salt, a glutamic acid salt (e.g., N-myristoyl-1-glutamic acid), a glycolic acid salt, a cholic acid salt, a carboxylic poly(ethylene glycol) ether (e.g., glycolic acid ethoxylate laurylphenyl ether, glycolic acid ethoxylate oleyl ether), a taurate (e.g., sodium oleic acid methyl taurate, sodium coconut fatty acid methyl taurate, sodium cocyl methyl taurate), or any combination thereof.

In some aspects, the anionic surfactant comprises an alkyl ether sulfate (AES). In general, the AES will have the structure R⁴—O-(EO)ₙSO₃⁻X⁺, in which R⁴ is a C₈-C₁₈ alkyl group (linear or branched), EO is polyethoxylate, n is typically 1 to 8 (e.g., 1, 2, 3, 4, 5, 6, 7, or 8), and X⁺ is a cation that balances the charge of the sulfonate. The C₈-C₁₈ alkyl group is an alkyl comprising 8 to 18 carbons (e.g., 8 to 16 carbons, 10 to 18 carbons, 10 to 16 carbons, 12 to 18 carbons, 12 to 16 carbons, such as C₈ alkyl, C₉ alkyl, C₁₀ alkyl, C₁₁ alkyl, C₁₂ alkyl, C₁₃ alkyl, C₁₄ alkyl, C₁₈ alkyl, C₁₆ alkyl, C₁₇ alkyl, or C₁₈ alkyl). In some aspects, the cation X⁺ can be a Group I cation, such as sodium cation or potassium cation, particularly sodium cation. In some aspects, the AES is sodium laureth sulfate.

In some aspects, the anionic surfactant comprises a linear alkylbenzene sulfonate (LAS). In some aspects, the LAS in the detergent composition is of Formula (I).

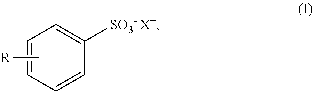

in which R is a linear C₁₀-C₁₈ (e.g., C₁₀, C₁₁, C₁₂, C₁₃, C₁₄, C₁₅, C₁₆, C₁₇, and C₁₈) alkyl, and X⁺ is a cation that balances the charge of the sulfonate. The phenylsulfonate can be at any suitable position (e.g., at the 1-position, 2-position, 3-position, 4-position, 5-position, 6-position, 7-position, 8-position, or 9-position) on the alkyl R. With respect to the benzene ring, the alkyl R and sulfonate can be ortho, meta, or para to each other. In some aspects, the alkyl R and sulfonate are para to one another.

In some aspects, the detergent composition does not comprise or is substantially free of a linear alkylbenzene sulfonate (LAS).

In some aspects, the anionic surfactant comprises an alkyl sulfate (e.g., a lauryl sulfate), a coconut fatty acid, a linear alkylbenzene sulfonate, an alkyl ether sulfate, a methyl ester sulfonate, or a combination thereof. In some aspects, the anionic surfactant comprises a linear alkylbenzene sulfonate, an alcohol ethoxysulfate, a methyl ester sulfonate, or a combination thereof. In some aspects, the anionic surfactant comprises an alkyl ether sulfate (AES).

A cationic surfactant comprises a hydrophobic tail group (e.g., a linear aliphatic chain) and a cationic hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The cationic hydrophilic group can be, for example, an amino group that can be quaternized, such as trialkylammonium. The counterion can be any suitable anion that can balance the charge. In some aspects, the counterion is an anion with a −1 charge (e.g., X⁻), such as a halide (e.g., chloride, bromide, etc.), hydroxy, or tosylate.

In some aspects, the cationic surfactant can be a fatty amine salt or a quaternary ammonium compound. In some aspects, the cationic surfactant comprises a fatty amine salt, a fatty diamine salt, a coco amine alkoxylate, an alkoxylated amine, an alkoxylated diamine, fatty quaternary ammonium compound, a fatty amide quaternary ammonium compound, an alkoxylated quaternary ammonium compound, a benzalkyl quaternary ammonium compound, or any combination thereof. Examples of the fatty amine salt include, e.g., a C₈-C₁₈ fatty amine salt (e.g., R⁵—NH₃⁺, in which R⁵ is a C₈-C₁₈ alkyl group). Examples of a fatty diamine salt include, e.g., R⁵—NH₂⁺—R⁶—NH₃⁺, in which R⁵ is a C₈-C₁₈ alkyl group and R⁶ is a C₁₋₆ alkyl. Examples of an alkoxylated amine and an alkoxylated diamine include a polyethoxylated fatty amine and diamine, respectively. Examples of a fatty quaternary ammonium compound include, e.g., R⁷—NR⁸₃_{⁺}, in which R⁷ is a C₈-C₁₈ alkyl group and each R⁸ is a C₁₋₄ alkyl, phenyl, or benzyl (e.g., alkyltrimethylammonium halide, alkyltrimethylammonium tosylate, alkyltrimethylammonium hydroxide). Examples of a fatty amide quaternary ammonium compound include, e.g., R⁹—C(O)N—R¹⁰—NR¹¹₃_{⁺}, in which R⁹ is a C₇-C₁₇ alkyl group, R¹⁰ is a C₁₋₆ alkyl, and each R¹¹ is a C₁₋₄ alkyl, phenyl, or benzyl (e.g., trimethylammonium stearamide). Examples of an alkoxylated quaternary ammonium compound include, e.g., a polyethoxylated quaternary ammonium compound. Examples of a benzalkyl quaternary ammonium compound include, e.g., benzyl-C₈-C₁₈ alkyldimethylammonium (e.g., benzalkonium chloride). In any of the foregoing examples, the C₈-C₁₈ alkyl group is an alkyl comprising 8 to 18 carbons (e.g., 8 to 16 carbons, 10 to 18 carbons, 10 to 16 carbons, 12 to 18 carbons, 12 to 16 carbons, such as C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, C₁₇ alkyl, or C₁₈ alkyl). In any of the forgoing examples, the C₇-C₁₇ alkyl group is an alkyl comprising 7 to 17 carbons (e.g., 7 to 16 carbons, 7 to 14 carbons, 7 to 12 carbons, 8 to 17 carbons, 8 to 16 carbons, 10 to 17 carbons, 10 to 16 carbons, 12 to 17 carbons, or 12 to 16 carbons, such as C₇ alkyl, C₈ alkyl, C₉ alkyl, C₁₀ alkyl, C₁₁ alkyl, C₁₂ alkyl, C₁₃ alkyl, C₁₄ alkyl, C₁₈ alkyl, C₁₆ alkyl, or C₁₇ alkyl).

In some aspects, the cationic surfactant can be alkoxylated, in which polyalkylene glycol (e.g., polyethylene glycol, polypropylene glycol) repeat units can be disposed between the hydrophobic tail group (e.g., a fatty group) and hydrophilic head group.

The zwitterionic surfactant is amphoteric and comprises a hydrophobic tail group (e.g., a linear aliphatic chain) and a hydrophilic head group with both a cationic charge and an anionic charge. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The cationic moiety can be, for example, a quaternary ammonium group, such as dialkylammonium or trialkylammonium (e.g., C₁-C₄ alkyl, such as methyl). The anionic moiety can be, for example, oxo (O⁻), a sulfate (—OSO₃—), sulfonate (—SO₃—), a phosphate (—OPO₃³⁻), a carboxylate (—C(O)O⁻, or the conjugate base of an organic acid.

In some aspects, the zwitterionic surfactant comprises a betaine, a sulfonated quaternary ammonium compound, a phosphonated quaternary ammonium compound, a trialkylamine N-oxide, or any combination thereof.

Examples of a betaine include, e.g., C₈-C₁₈ alkyl betaine, cocobetaine, cocamidopropyl betaine, amidosulfobetaine-16, hexadecyl hydroxypropyl sulfobetaine, lauryl-N,N-(dimethylammonio)butyrate, and lauryl-N,N-(dimethyl)-glycinebetaine. Examples of a sulfonated quaternary ammonium compound include, e.g., 3-(N,N-dimethyl-octylammonio)propanesulfonate, 4-(N,N-dimethyl-dodecylammonio)butanesulfonate, 3-{N,N-dimethyl-N-[3-(4-octylbenzoylamino)propyl]ammonio}propanesulfonate, 3-[(3-cholamidopropyl)dimethylammonio]-1-propanesulfonate, 3-([3-cholamidopropyl]dimethylammonio)-2-hydroxy-1-propanesulfonate, coco(amidopropyl)dimethylammonio-2-hydroxypropanesulonate, lauryl-N,N-(dimethylammonio)butyrate, lauryl-N,N-(dimethyl)-propanesulfonate, 3-(4-tert-butyl-1-pyridinio)-1-propanesulfonate, 3-(1-pyridinio)-1-propanesulfonate, and 3-(benzyl-dimethylammonio)propanesulfonate. Examples of a phosphonated quaternary ammonium compound include, e.g., a phosphocholine, such as N-dodecylphosphocholine and hexadecyl phosphocholine. Examples of a trialkylamine N-oxide include, e.g., R⁴—N(O—)R⁵₂_{⁺}, in which R⁴ is a C₈-C₁₈ alkyl group, R⁵ is a C₁₋₄ alkyl, such as lauryldimethylamine N-oxide and 4-ethyl-N,N-2-trimethyloctan-1-amine oxide.

A nonionic surfactant comprises a hydrophobic tail group (e.g., a linear aliphatic chain) and an uncharged (i.e., neutral) hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The uncharged hydrophilic group can be, for example, an alkoxylate, such as ethoxylate ((—CH₂CH₂O—)ⁿ; EO or PEO) or propoxylate ((—CH(CH₃)CH₂O—)ₘ; PO or PPO), in which n and m are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

In some aspects, the nonionic surfactant comprises a methyl ester ethoxylate, an alcohol alkoxylate, a fatty acid alkoxylate, an alkyl phenol ethoxylate, an alkoxylated amine, an alkyl glucoside, a fatty amide alkoxylate, a diester of alkoxylated fatty acid, a glycerol fatty ester, castor oil alkoxylate, an ethylene oxide-propylene oxide block copolymer, a phenol alkoxylate, or a combination thereof.

Examples of an alcohol alkoxylate include, e.g., C₈-C₁₈ ethoxylate and C₈-C₁₈ propoxylate. Examples of a fatty acid alkoxylate include, e.g., R¹²—C(O)O-EO-H, in which R¹² is a C₇-C₁₇ alkyl group and EO is polyethoxylate. Examples of an alkyl phenol ethoxylate include, e.g., R¹²-phenyl-O(EO)—H, in which R¹² is a C₈-C₁₈ alkyl group and EO is polyethoxylate. Examples of an alkoxylated amine include, e.g., ethoxylated C₈-C₁₈ alkylamine, tallow amine ethoxylate, lauryl amine ethoxylate ether, 2-2-(2-hydroxyethoxy)ethylaminoethanol, bis(hydroxyethoxyethyl)amine, 2,2′-((2-(2-hydroxyethoxy)ethyl)azanediyl)diethanol, and coco bis(2-hydroxyethyl) amine. Example of an alkyl glucoside include, e.g., alkyl polyglucoside, such as C₈-C₁₈ polyglucoside which can include 1 to 3 glucoside units. Examples of a fatty amide alkoxylate include R¹³—C(O)NH-(EO)—H, in which R¹³ is a C₇-C₁₇ alkyl group and EO is polyethoxylate. Examples of a diester of alkoxylated fatty acid include, e.g., R¹⁴—C(O)O-EO—C(O)—R^{14′}, in which R¹⁴ and R^{14′} is a C₇-C₁₇ alkyl group and EO is polyethoxylate. Examples of an alkoxylated methyl ester of fatty acid (e.g., a methyl ester ethoxylate) include e.g., R¹¹—C(O)O-EO-R¹⁶, in which R¹⁵ is a C₇-C₁₇ alkyl group, R¹⁶ is a C₁-C₄ alkyl group, and EO is polyethoxylate. Examples of a glycerol fatty ester include, e.g., an ester formed from glycerol and a fatty acid (e.g., C₈-C₁₈ alkyl), such as 2-ethylhexyl oleate, glycerol trioleate, glyceryl monooleate, glyceryl monotallate, n-butyl stearate, neopentylglycol dioleate, pentaerythritol monooleate, pentaerythritol tetraoleate, and trimethylolpropane trioleate. An example of a castor oil alkoxylate is polyethoxylated castor oil. Examples of an ethylene oxide-propylene oxide block copolymer include, e.g., R¹⁷O-(EO)ₙ—(PO)ₘ-(EO)ⁿ—R¹⁸, in which R¹⁷ and R¹⁸ are the same or different and each is a C₁-C₇ alkyl, a C₅-C₆ cycloalkyl, or an aryl; n is an integer of 30-150 (e.g., about 40-135, about 42-133), and m is an integer of about 10-100 (e.g., about 10-80, about 20-70, about 21-68) and block copolymers such as, PEO—PPO-PEO and PPO-PEO-PPO. Examples of a phenol alkoxylate include, e.g., R⁵—C₆H₄-(EO)—H, wherein R⁵ is hydrogen or a C₁-C₁₅ alkyl group, and EO is polyethoxylate, such as octyphenol ethoxylate, nonylphenol ethoxylate, 2-phenoxydecan-1-ol, bisphenol ethoxylate, and a styrenated phenol ethoxylate (e.g., tristyrylphenol ethoxylate). In any of the foregoing examples, the C₈-C₁₈ alkyl group is an alkyl comprising 8 to 18 carbons (e.g., 8 to 16 carbons, 10 to 18 carbons, 10 to 16 carbons, 12 to 18 carbons, 12 to 16 carbons, such as C₈ alkyl, C₉ alkyl, C₁₀ alkyl, C₁₁ alkyl, C₁₂ alkyl, C₁₃ alkyl, C₁₄ alkyl, C₁₈ alkyl, C₁₆ alkyl, C₁₇ alkyl, or C₁₈ alkyl). In any of the foregoing embodiments, the C₇-C₁₇ alkyl group is an alkyl comprising 7 to 17 carbons (e.g., 7 to 16 carbons, 7 to 14 carbons, 7 to 12 carbons, 8 to 17 carbons, 8 to 16 carbons, 10 to 17 carbons, 10 to 16 carbons, 12 to 17 carbons, or 12 to 16 carbons, such as C₇ alkyl, C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, or C₁₇ alkyl).

In general, the alcohol ethoxylate (AE) will have a chemical structure of formula (I):

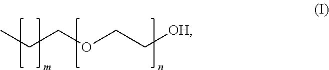

in which m is an integer of 10 to 16 (e.g., 10, 11, 12, 13, 14, 15, or 16) to form a C₁₂-C₁₈ fatty alkyl (e.g., C₁₂, C₁₃, C₁₄, C₁₅, C₁₆, C₁₇, and Cis), and n is an integer of 1 to 15 (e.g., 1, 2, 3, 4, 5, 6, 7, 8, 9, 10, 11, 12, 13, 14, or 15). The alcohol ethoxylate typically will contain a range of alkyl groups, such as C₁₂-C₁₅ or C₁₂-C₁₄ and can contain branches. In some aspects, the fatty alcohol ethoxylate can contain 1 to 15 moles (e.g., 1 to 12 moles, 1 to 9 moles, 1 to 7 moles, or about 7 moles) of ethoxylate per mole of alcohol. In some aspects, the fatty alcohol ethoxylate can be a C₁₂-C₁₈ fatty alcohol ethoxylate with 1-15 moles of ethoxylate. In some aspects, the fatty alcohol ethoxylate comprises a C₁₂-C₁₅ fatty alcohol ethoxylate with 7 moles of ethoxylate. In some aspects, the alcohol ethoxylate comprises ethoxylated lauryl alcohol.

In some aspects, the detergent composition comprises an alcohol ethoxylate (AE), an alkyl ether sulfate (AES), a coconut fatty acid, or any combination thereof. In some aspects, detergent composition comprises combination of an alcohol ethoxylate (AE), an alkylether sulfate (AES), and a coconut fatty acid. In some aspects, the detergent composition comprises an alcohol ethoxylate (AE) and an alkyl ether sulfate (AES). In some of these aspects, the detergent composition comprises an alcohol ethoxylate (AE) and an alkyl ether sulfate (AES) and does not comprise (e.g., is substantially free of) a linear alkylbenzene sulfonate.

The detergent composition comprises from about 15 wt % to about 40 wt % of at least one surfactant (e.g., an alcohol ethoxylate (AE), an alkyl ether sulfate (AES), a coconut fatty acid, or any combination thereof) relative to the total weight of the detergent composition. For example, the total surfactant content can be from about 15 wt % to about 38 wt %, about 15 wt % to about 35 wt %, about 15 wt % to about 32 wt %, about 15 wt % to about 30 wt %, about 15 wt % to about 25 wt %, about 15 wt % to about 22 wt %, about 15 wt % to about 20 wt %, about 18 wt % to about 40 wt %, about 18 wt % to about 38 wt %, about 18 wt % to about 35 wt %, about 18 wt % to about 32 wt %, about 18 wt % to about 30 wt %, about 18 wt % to about 25 wt %, about 18 wt % to about 22 wt %, about 18 wt % to about 20 wt %, about 20 wt % to about 40 wt %, about 20 wt % to about 38 wt %, about 20 wt % to about 35 wt %, about 20 wt % to about 32 wt %, about 20 wt % to about 30 wt %, about 20 wt % to about 25 wt %, about 20 wt % to about 22 wt %, about 22 wt % to about 40 wt %, about 22 wt % to about 38 wt %, about 22 wt % to about 35 wt %, about 22 wt % to about 30 wt %, about 22 wt % to about 25 wt %, about 25 wt % to about 40 wt %, about 25 wt % to about 38 wt %, about 25 wt % to about 35 wt %, about 25 wt % to about 30 wt %, about 28 wt % to about 40 wt %, about 28 wt % to about 38 wt %, about 28 wt % to about 35 wt %, about 28 wt % to about 30 wt %, about 30 wt % to about 40 wt %, about 30 wt % to about 38 wt %, about 30 wt % to about 35 wt %, about 32 wt % to about 40 wt %, about 32 wt % to about 38 wt %, about 32 wt % to about 35 wt %, about 35 wt % to about 40 wt %, about 35 wt % to about 38 wt %, about 38 wt % to about 40 wt %, about 40 wt %, about 39 wt %, about 38 wt %, about 37 wt %, about 36 wt %, about 35 wt %, about 34 wt %, about 33 wt %, about 32 wt %, about 31 wt %, about 30 wt %, about 29 wt %, about 28 wt %, about 27 wt %, about 26 wt %, about 25 wt %, about 24 wt %, about 23 wt %, about 22 wt %, about 21 wt %, about 20 wt %, about 19 wt %, about 18 wt %, about 17 wt %, about 16 wt %, or about 15 wt %, of the total weight of the detergent composition. In some aspects, the detergent composition comprises about 15 to about 30 wt % of at least one surfactant (e.g., alcohol ethoxylate (AE) and an alkyl ether sulfate (AES)). In some aspects, the detergent composition comprises about 18 to about 22 wt % of at least one surfactant (e.g., alcohol ethoxylate (AE) and an alkyl ether sulfate (AES)).

The detergent composition comprises at least one (e.g., 1, 2, 3, 4, 5, or 6, etc.) enzyme to aid in removing stains, including protein stains, oil stains, tannin stains, starch stains, and dyes. For example, a protease is capable of breaking down protein-based stains, such as sweat, blood, mud, and dairy products. An amylase is capable of breaking down a starch-based stain, such as cornstarch or potato starch. A lipase is capable of breaking down fats. A mannanase is capable of breaking down guar and locust bean stains. In some aspects, the at least one enzyme is a hydrolytic enzyme. The at least one enzyme can comprise a protease, an amylase, a mannanase, a lactase, a lipase, a perhydrolase, an oxidoreductase, an endocellulase, an exocellulase, or a combination thereof. In some aspects, the detergent composition comprises a protease, an amylase, a mannanase, or a combination thereof.

In some aspects, the detergent composition comprises a total from about 0.01 wt % to about 5 wt % of at least one enzyme (e.g., a protease, an amylase, a mannanse, or a combination thereof) relative to the total weight of the detergent composition. For example, the total enzyme content can from about 0.01 wt % to about 4 wt %, about 0.01 wt % to about 3 wt %, about 0.01 wt % to about 2 wt %, about 0.01 wt % to about 1 wt %, about 0.05 wt % to about 5 wt %, about 0.05 wt % to about 4 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.5 wt % to about 5 wt %, about 0.5 wt % to about 3 wt %, about 0.5 wt % to about 2 wt %, about 0.5 wt % to about 1 wt %, about 1 wt % to about 5 wt %, about 1 wt % to about 4 wt %, about 1 wt % to about 3 wt %, about 1 wt % to about 2 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.2 wt %, about 4.5 wt %, about 4.8 wt %, or about 5 wt % of the total weight of the detergent composition. In some aspects, the detergent composition comprises a total from about 0.05 wt % to about 3 wt % of at least one enzyme (e.g., a protease, an amylase, a mannanse, or a combination thereof). In some aspects, the detergent composition comprises a total from about 0.5 wt % to about 2 wt % of at least one enzyme (e.g., a protease, an amylase, a mannanse, or a combination thereof). In some aspects, the detergent composition comprises a total from about 1 wt % to about 1.5 wt % of at least one enzyme (e.g., a protease, an amylase, a mannanse, or a combination thereof).

The detergent composition has an alkaline pH, i.e., a pH of about 10 to about 12. In some aspects, the detergent composition has a pH of geater than 10 (e.g., about 10.1, about 10.2, about 10.3, or about 10.4) to about 12. In some aspects, the detergent composition has a pH of about 10.5 to about 12 (e.g., about 10.5 to about 11.8, about 10.5 to about 11.5, about 10.5 to about 11.2, about 10.5 to about 11). In some aspects, the detergent composition has a pH of about 10, about 10.1, about 10.2, about 10.3, about 10.4, about 10.5, about 10.6, about 10.7, about 10.8, about 10.9, about 11, about 11.1, about 11.2, about 11.3, about 11.4, about 11.5, about 11.6, about 11.7, about 11.8, about 11.9, or about 12. In some aspects, the detergent composition has a pH of about 10.5 to about 11.

In some aspects, the detergent composition comprises a base to adjust the pH. The base can be any suitable compound with a pKb of about 0.1 to about 13. In some aspects, the base can be monoethanolamine, diethanolamine, triethanolamine, methyl diethanolamine, a hydroxide, a tetraborate, a phosphate, a carbonate, a bicarbonate, or any combination thereof. The base can include a counterion, such as a Group I cation or Group II cation. In some aspects, the base is a Group I hydroxide, a Group II hydroxide, sodium tetraborate, trisodium phosphate, sodium carbonate, or a combination thereof. In some aspects, the base can be a monoethanolamine, sodium carbonate, or a Group I hydroxide (e.g., sodium hydroxide, potassium hydroxide, or a combination of both). In some aspects, the base can be a base solution (e.g., a base in water). In some aspects, the detergent composition comprises a carbonate, such as sodium carbonate. In some aspects, the base in the detergent composition comprises a hydroxide (e.g., sodium hydroxide). In some aspects, the base comprises sodium hydroxide solution (e.g., 50% sodium hydroxide solution), sodium carbonate solution (e.g., 20% sodium carbonate solution), or a combination of both.

In some aspects, the detergent composition comprises from about 0.1 wt % to about 15 wt % of base (e.g., a Group I hydroxide, a Group I carbonate) relative to the total weight of the detergent composition. For example, the base can be present in an amount from about 0.1 wt % to about 12 wt %, about 0.1 wt % to about 10 wt %, about 0.5 wt % to about 15 wt %, about 0.5 wt % to about 12 wt %, about 0.5 wt % to about 10 wt %, about 1 wt % to about 15 wt %, about 1 wt % to about 14 wt %, about 1 wt % to about 13 wt %, about 1 wt % to about 12 wt %, about 1 wt % to about 11 wt %, about 1 wt % to about 10 wt %, about 1 wt % to about 9 wt %, about 1 wt % to about 8 wt %, about 1 wt % to about 5 wt %, about 1 wt % to about 3 wt %, about 1.5 wt % to about 15 wt %, about 1.5 wt % to about 10 wt %, about 1.5 wt % to about 8 wt %, about 1.5 wt % to about 5 wt %, about 1.5 wt % to about 3 wt %, about 2 wt % to about 15 wt %, about 2 wt % to about 10 wt %, about 2 wt % to about 8 wt %, about 2 wt % to about 5 wt %, about 2 wt % to about 3 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 11 wt %, about 12 wt %, about 13 wt %, about 14 wt %, or about 15 wt % of the total weight of the detergent composition. In some aspects, the detergent composition comprises from about 1 wt % to about 8 wt %, from about 1 wt % to about 5 wt %, or from about 3 wt % to about 5 wt % of base.

In some aspects, the detergent composition can further comprise at least one additive. The additive is any suitable component that does not reduce the at least one amino acid's ability to scavenge chlorine. For example, the at least one (e.g., 1, 2, 3, 4, 5, or 6, etc.) additive can be selected from a performance polymer, an anti-redeposition agent, a defoamer, a chelating agent, a biocide, and any combination thereof.

In some aspects, the detergent composition comprises from about 1 wt % to about 10 wt % of a total amount of additives relative to the total weight of the detergent composition. For example, the total amount of additives can be from about 1 wt % to about 8 wt %, about 1 wt % to about 5 wt %, about 1 wt % to about 3 wt %, about 1.5 wt % to about 10 wt %, about 1.5 wt % to about 8 wt %, about 1.5 wt % to about 5 wt %, about 1.5 wt % to about 3 wt %, about 2 wt % to about 10 wt %, about 2 wt % to about 8 wt %, about 2 wt % to about 5 wt %, about 2 wt % to about 3 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the detergent composition.

In some aspects, the detergent composition comprises a performance polymer that improves at least one aspect of a washed textile. In some aspects, the performance polymer improves the cleaning action of the detergent composition, removes or reduces stains, maintains whiteness, protects color, protects the integrity of a textile, provides odor control, or any combination thereof. In some aspects the performance polymer comprises polyethyleneimine ethoxylate, polyethyleneimine ethoxylate propoxylate, a polycarboxylate (e.g., an acrylic homopolymer or copolymer), carboxymethylcellulose, a polyester, polyvinyl pyrrolidone, a copolymer comprising terephthalic acid, a copolymer comprising maleic acid, a copolymer comprising acrylamino tertiary butyl sulfonate, or any combination thereof. In some aspects the performance polymer comprises an alkoxylated polyethyleneimine, such as polyethyleneimine ethoxylate, polyethyleneimine ethoxylate propoxylate, or a combination of both.

In some aspects, the detergent composition comprises from about 0.001 wt % to about 5 wt % of the performance polymer relative to the total weight of the detergent composition. For example, the performance polymer can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the detergent composition. In some aspects, the detergent composition comprises from about 0.1 wt % to about 1 wt % of the performance polymer.

In some aspects, the detergent composition comprises an anti-redeposition agent that keeps dissolved soil stains stable in the wash water and prevent the stains from redepositing on a textile. In some aspects, the anti-redeposition agent is a biodegradable polymer. The anti-redeposition agent (e.g., anti-redeposition polymer) can be based on acrylic acid, e.g., a homopolymer of acrylic acid, a polycarboxylate based on acrylic acid, a copolymer of acrylic acid and polystyrene, or a copolymer of maleic acid and acrylic acid. Examples of a suitable anti-redeposition agent include, e.g., sodium polyacrylate, modified polyethylene glycol, styrene-acrylic acid copolymer, polyethyleneimine, or a combination thereof. In some aspects, the anti-redeposition agent comprises sodium polyacrylate.

In some aspects, the detergent composition comprises from about 0.001 wt % to about 5 wt % of the anti-redeposition agent relative to the total weight of the detergent composition. For example, the anti-redeposition agent can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the detergent composition. In some aspects, the detergent composition comprises from about 0.1 wt % to about 1 wt % of the anti-redeposition agent.

In some aspects, the detergent composition comprises a defoamer that helps maintain the rise of foam, which can, in some aspects, avoid high foaming or water spilling from a washing machine. In general, the defoamer has a low viscosity. In some aspects the defoamer comprises coconut fatty acid, a silicone, ethylene-bis-stearamide, a fatty acid, a fatty alcohol, or any combination thereof. In an aspect, the defoamer is coconut fatty acid.

In some aspects, the detergent composition comprises from about 0.1 wt % to about 10 wt % of a defoamer relative to the total weight of the detergent composition. For example, the defoamer can be from about 0.1 wt % to about 8 wt %, about 0.1 wt % to about 5 wt %, about 0.1 wt % to about 3 wt %, about 0.5 wt % to about 10 wt %, about 0.5 wt % to about 8 wt %, about 0.5 wt % to about 5 wt %, about 0.5 wt % to about 3 wt %, about 1 wt % to about 10 wt %, about 1 wt % to about 9 wt %, about 1 wt % to about 8 wt %, about 1 wt % to about 5 wt %, about 1 wt % to about 3 wt %, about 1.5 wt % to about 10 wt %, about 1.5 wt % to about 8 wt %, about 1.5 wt % to about 5 wt %, about 1.5 wt % to about 3 wt %, about 2 wt % to about 10 wt %, about 2 wt % to about 8 wt %, about 2 wt % to about 5 wt %, about 2 wt % to about 3 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the detergent composition. In some aspects, the detergent composition comprises from about 1 wt % to about 5 wt % or about 1 wt % to about 3 wt % of a defoamer (e.g., coconut fatty acid) relative to the total weight of the detergent composition.

In some aspects, the detergent composition comprises a chelating agent (i.e., a chelant) that serves to improve the cleaning action of the detergent by scavenging metal ions naturally found in water. Suitable examples of a chelating agent includes, e.g., citric acid, oxalic acid, nitriloacetic acid, phosphoric acid, polyphosphoric acid (e.g., a polyphosphate, such as tripolyphosphate), a phosphonate, ethylenediaminetetraacetic acid, diethylenetriaminepentaacetic acid (pentetic acid), hydroxyethylethylenediaminetriacetic acid, glutamic acid, aspartic acid, iminodisuccinic acid, any salt thereof (e.g., sodium citrate, disodium edetate, tetrasodium glutamate diacetate, tetrasodium aspartate diacetate, tetrasodium iminodisuccinate), or any combination thereof. In some aspects, the detergent composition comprises iminodisuccinic acid and/or tetrasodium iminodisuccinate.

In some aspects, the detergent composition comprises from about 0.001 wt % to about 5 wt % of a chelating agent relative to the total weight of the detergent composition. For example, the chelating agent can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the detergent composition. In some aspects, the detergent composition comprises from about 1 wt % to about 5 wt % of a chelating agent.

In some aspects, the detergent composition comprises a biocide, which is any suitable compound with antimicrobial (e.g., antibacterial, antiviral, antifungal) activity. In an aspect, the biocide can act as a preservative in the detergent composition. Examples of a biocide include, e.g., dichloroisocyanuric acid, hydrogen peroxide, a quaternary ammonium compound, glutaraldehyde, tetrakis(hydroxymethyl)phosphonium sulfate (THPS), 2,2-dibromo-3-nitrilopropionamide (DBNPA), 2,2-dibromo-3-nitrilpropionamide, 2-(hydroxymethylamino)-ethanol, 2-bromo-2-nitropropane-1,3-diol, β-bromo-β-nitrostyrene, 1,2-dibromo-2,4-dicyanobutane (DBDCB), 2,2-dibromo-3-nitrilopropionamide (DBNPA), 3-iodo-2-propynylbutyl carbamate (IPBC), chlorthalonil, 1-bromo-3-chloro-5,5-dimethylhydantoin, 5-chloro-2-methyl-4-isothiazolin-3-one, 2-methyl-4-isothiazolin-3-one, 1,2-benzisothiazolin-3-one, and combinations thereof. In some aspects, the biocide can be 5-chloro-2-methyl-4-isothiazolin-3-one, 2-methyl-4-isothiazolin-3-one, 1,2-benzisothiazolin-3-one, or a combination thereof.

In some aspects, the detergent composition comprises from about 0.001 wt % to about 5 wt % of a biocide relative to the total weight of the detergent composition. For example, the biocide can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the detergent composition. In some aspects, the detergent composition comprises from about 0.05 wt % to about 1 wt % or about 0.1 wt % to about 0.5 wt % of a biocide.

In some aspects, the detergent composition comprises a combination of a performance polymer, an anti-redeposition polymer, a defoamer, a chelating agent, and a biocide as additives. In some aspects, the detergent composition comprises a combination of polyethyleneimine ethoxylate, polyethyleneimine ethoxylate propoxylate, or any combination of both, sodium polyacrylate, iminodisuccinic acid and/or tetrasodium iminodisuccinate, and a biocide as additives.

In an aspect, the detergent composition comprises water, at least one surfactant, at least one amino acid or a salt thereof, and at least one enzyme, wherein the detergent composition has a pH of about 10 to about 12. In an aspect, the detergent composition comprises:
about 50 wt % to about 80 wt % water;
about 15 wt % to about 40 wt % of at least one surfactant;
about 0.001 wt % to about 5 wt % of total amount of at least one amino acid or a salt thereof;
about 0.01 wt % to about 5 wt % of at least one enzyme, and
optionally about 1 wt % to about 10 wt % of at least one additive (e.g., a base, a performance polymer, an anti-redeposition polymer, a defoamer, a chelating agent, a biocide, and any combination thereof), wherein the detergent composition has a pH of about 10 to about 12 (e.g., about 10.5 to about 11). The amounts of each component will be selected to provide a detergent composition comprising 100 wt % of the total composition.

In an aspect, the the detergent composition consists essentially of:
about 50 wt % to about 80 wt % water;
about 15 wt % to about 40 wt % of at least one surfactant;
about 0.001 wt % to about 5 wt % of total amount of at least one amino acid or a salt thereof;
about 0.01 wt % to about 5 wt % of at least one enzyme, and
optionally about 1 wt % to about 10 wt % of at least one additive (e.g., a base, a performance polymer, an anti-redeposition polymer, a defoamer, a chelating agent, a biocide, and any combination thereof),
wherein the detergent composition has a pH of about 10 to about 12 (e.g., about 10.5 to about 11). The amounts of each component will be selected to provide a detergent composition comprising 100 wt % of the total composition.

In an aspect, the detergent composition consists of:
about 50 wt % to about 80 wt % water;
about 15 wt % to about 40 wt % of at least one surfactant;
about 0.001 wt % to about 5 wt % of total amount of at least one amino acid or a salt thereof;
about 0.01 wt % to about 5 wt % of at least one enzyme, and
optionally about 1 wt % to about 10 wt % of at least one additive (e.g., a base, a performance polymer, an anti-redeposition polymer, a defoamer, a chelating agent, a biocide, and any combination thereof),
wherein the detergent composition has a pH of about 10 to about 12 (e.g., about 10.5 to about 11). The amounts of each component will be selected to provide a detergent composition comprising 100 wt % of the total composition.

In an aspect, the detergent composition comprises:
about 55 wt % to about 75 wt % water;
about 15 wt % to about 30 wt % of at least one surfactant (e.g., at least one anionic surfactant and at least one nonionic surfactant);
about 0.25 wt % to about 2 wt % of total amount of at least one amino acid or a salt thereof (e.g., lysine, arginine, threonine, any salt thereof, or any combination thereof, including salts thereof);
about 0.05 wt % to about 3 wt % of at least one enzyme, and
optionally about 1 wt % to about 10 wt % of at least one additive (e.g., a combination of a base, a performance polymer, an anti-redeposition polymer, a defoamer, a chelating agent, a biocide),
wherein the detergent composition has a pH of about 10 to about 12 (e.g., about 10.5 to about 11). The amounts of each component will be selected to provide a detergent composition comprising 100 wt % of the total composition. In some aspects of this composition, the at least one surfactant is selected from an alkylether sulfate, an alcohol ethoxylate, and coconut fatty acid.

In an aspect, the detergent composition consists essentially of:
about 55 wt % to about 75 wt % water;
about 15 wt % to about 30 wt % of at least one surfactant (e.g., at least one anionic surfactant and at least one nonionic surfactant);
about 0.25 wt % to about 2 wt % of total amount of at least one amino acid or a salt thereof (e.g., lysine, arginine, threonine, any salt thereof, or any combination thereof, including salts thereof);
about 0.05 wt % to about 3 wt % of at least one enzyme, and
optionally about 1 wt % to about 10 wt % of at least one additive (e.g., a combination of a base, a performance polymer, an anti-redeposition polymer, a defoamer, a chelating agent, a biocide),
wherein the detergent composition has a pH of about 10 to about 12 (e.g., about 10.5 to about 11). The amounts of each component will be selected to provide a detergent composition comprising 100 wt % of the total composition. In some aspects of this composition, the at least one surfactant is selected from an alkylether sulfate, an alcohol ethoxylate, and coconut fatty acid.

In an aspect, the detergent composition consists of:
about 55 wt % to about 75 wt % water;
about 15 wt % to about 30 wt % of at least one surfactant (e.g., at least one anionic surfactant and at least one nonionic surfactant);
about 0.25 wt % to about 2 wt % of total amount of at least one amino acid or a salt thereof (e.g., lysine, arginine, threonine, any salt thereof, or any combination thereof, including salts thereof);
about 0.05 wt % to about 3 wt % of at least one enzyme, and
optionally about 1 wt % to about 10 wt % of at least one additive (e.g., a combination of a base, a performance polymer, an anti-redeposition polymer, a defoamer, a chelating agent, a biocide),
wherein the detergent composition has a pH of about 10 to about 12 (e.g., about 10.5 to about 11). The amounts of each component will be selected to provide a detergent composition comprising 100 wt % of the total composition. In some aspects of this composition, the at least one surfactant is selected from an alkylether sulfate, an alcohol ethoxylate, and coconut fatty acid.

In an aspect, the detergent composition comprises:
about 55 wt % to about 75 wt % water;
about 15 wt % to about 30 wt % of at least one surfactant selected from an alkylether sulfate, an alcohol ethoxylate, and coconut fatty acid;
about 0.25 wt % to about 2 wt % of total amount lysine, arginine, a salt thereof, or any combination thereof;
about 0.05 wt % to about 3 wt % of at least one enzyme, a base comprising a hydroxide and a carbonate, and
optionally at least one additive selected from a performance polymer, an anti-redeposition polymer, a defoamer, a chelating agent, and a biocide,
wherein the detergent composition has a pH of about 10 to about 12 (e.g., about 10.5 to about 11). The amounts of each component will be selected to provide a detergent composition comprising 100 wt % of the total composition.

In an aspect, the detergent composition consists essentially of:
about 55 wt % to about 75 wt % water;
about 15 wt % to about 30 wt % of at least one surfactant selected from an alkylether sulfate, an alcohol ethoxylate, and coconut fatty acid;
about 0.25 wt % to about 2 wt % of total amount lysine, arginine, a salt thereof, or any combination thereof;
about 0.05 wt % to about 3 wt % of at least one enzyme, a base comprising a hydroxide and a carbonate, and
optionally at least one additive selected from a performance polymer, an anti-redeposition polymer, a defoamer, a chelating agent, and a biocide,
wherein the detergent composition has a pH of about 10 to about 12 (e.g., about 10.5 to about 11). The amounts of each component will be selected to provide a detergent composition comprising 100 wt % of the total composition.

In an aspect, the detergent composition consists of:
about 55 wt % to about 75 wt % water;
about 15 wt % to about 30 wt % of at least one surfactant selected from an alkylether sulfate, an alcohol ethoxylate, and coconut fatty acid;
about 0.25 wt % to about 2 wt % of total amount lysine, arginine, a salt thereof, or any combination thereof;
about 0.05 wt % to about 3 wt % of at least one enzyme, a base comprising a hydroxide and a carbonate, and
optionally at least one additive selected from a performance polymer, an anti-redeposition polymer, a defoamer, a chelating agent, and a biocide,
wherein the detergent composition has a pH of about 10 to about 12 (e.g., about 10.5 to about 11). The amounts of each component will be selected to provide a detergent composition comprising 100 wt % of the total composition.

In some aspects, the detergent composition is a liquid, including a liquid that is dispensed from a container upon use.

It was unexpectedly discovered that the amino acid in the detergent composition can act as a chlorine scavenger. Water from a municipal source can contain up to 4 ppm chlorine. In some aspects, the detergent composition can scavenge (e.g., reduce) chlorine to a concentration of 0 ppm in less than about 120 sec (e.g., less than about 115 sec, less than about 110 sec, less than about 105 sec, less than about 100 sec, less than about 95 sec, less than about 90 sec, less than about 85 sec, less than about 80 sec, less than about 75 sec, less than about 70 sec, less than about 65 sec, less than about 60 sec, less than about 55 sec, less than about 50 sec, less than about 45 sec, less than about 40 sec, less than about 35 sec, less than about 30 sec, less than about 25 sec, or less than about 20 sec) after initial contact (time=0 sec) with a 1 L sample of water that comprises up to 4 ppm (e.g., up to 3.5 ppm, up to 3 ppm, up to 2.5 ppm, up to 2 ppm, up to 1.5 ppm, or up to 1 ppm) chlorine. In some instances of this method, the water sample will be agitated after the addition of the detergent composition. In some aspects, the detergent composition can scavenge (e.g., reduce) chlorine to a concentration of 0 ppm in less than about 120 sec or less than about 60 sec or less than about 30 sec after contact with a 1 L water sample comprising up to 4 ppm chlorine.

In some aspects, the present disclosure is directed to a method of using the detergent composition of any of the foregoing aspects. For example, the detergent composition can be used in a method of removing soil from a textile (e.g., cleaning a textile, such as a fabric). In particular, the present disclosure is directed to a method of removing soil from a textile comprising contacting the textile with a composition comprising the detergent composition described herein and water to form a washing load. Optional steps include mixing (agitating) the washing load and composition, removing the detergent composition to provide a clean textile, rinsing the clean textile with additional water, and isolating the clean textile. In some aspects, soils that are suitably removed using the detergent composition include, but are not limited to, oil-containing soils, carbohydrate-containing soils, protein-containing soils, tannin-containing soils, particulate soils, and combinations thereof.

In an aspect, the method is directed to protecting a color of a textile (e.g., fabric) comprising adding the detergent composition described herein to water to form a composition and reduce the chlorine level of the water; and contacting the textile with the detergent composition to form a washing load. Optional steps include mixing (agitating) the washing load and composition, removing the detergent composition to provide a clean textile, rinsing the clean textile with additional water, and isolating the clean textile.

The color level of a textile can be measured using any suitable technique, such as spectrophotometry. The color of a textile is protected when the color level of a textile from a starting point (e.g., day 0) and the color level of the same textile after 3 to 30 (e.g., 3 to 25, 3 to 20, 3 to 15, 3 to 10, or 3 to 5) washes (each wash corresponding to a day) with the detergent composition described herein differs by less than about 15% (e.g., less than about 10%, less than about 8%, less than about 5%, less than about 3%, less than about 2%, or less than about 1%).

In some aspects of these methods, the method can be performed using a washing machine, a tergotometer, or an equivalent device. In some aspects of these methods, the textile is a fabric comprising a red, blue, or black dye. In some aspects of these methods, the water is hot or warm water. In some aspects of these methods, the water is cold water. In some aspects of these methods, the water is municipal water.

### EXAMPLES

These examples are provided for the purpose of illustration only and the embodiments described herein should in no way be construed as being limited to these examples. Rather, the embodiments should be construed to encompass any and all variations which become evident as a result of the teaching provided herein.

### Example 1

Comparative Formulas A and B and inventive Formulas 1-3 were prepared in accordance with the components listed in Table 1 using a standard overhead mixer. The target pH was about 10.5 to about 11.

TABLE 1

| | Formula A | Formula B | Formula 1 | Formula 2 | Formula 3 |
|---|---|---|---|---|---|
| | (Comparative) | (Comparative) | (Inventive) | (Inventive) | (Inventive) |
| Component | wt % | wt % | wt % | wt % | wt % |
| Water, demineralized | 72.21 | 70.92 | 70.22 | 69.45 | 70.42 |
| Fatty alcohol ethoxylate | 12 | 12 | 12 | 12 | 12 |
| (C₁₂₋₁₅, 7EO) | | | | | |
| Sodium laureth sulfate, | 8.57 | 8.57 | 8.57 | 8.57 | 8.57 |
| 3EO, 70% paste | | | | | |
| Sodium hydroxide, 50% | — | — | 0.2 | 0.47 | — |
| Sodium carbonate, 20% | 3.75 | 3.75 | 3.75 | 3.75 | 3.75 |
| Anti-redeposition | 3.3 | 3.3 | 3.3 | 3.3 | 3.3 |
| polymer, Alkoxylated | | | | | |
| polyethyleneimine, and | | | | | |
| tetrasodium | | | | | |
| iminodisuccinate (34% | | | | | |
| active), Coconut Fatty | | | | | |
| Acid | | | | | |
| Protease, amylase, | — | 1.3 | 1.3 | 1.3 | 1.3 |
| and mannanase | | | | | |
| L-lysine HCl | — | — | 0.5 | 1 | — |
| L-arginine base | — | — | — | — | 0.5 |
| Total | 100 | 100 | 100 | 100 | 100 |

After batching, the formulas were analyzed for protease and amylase activity at the time of preparation (initial activity=100%) and after 2 weeks and 4 weeks aging at 37° C. The results of percent activity after aging are set forth in Table 2.

TABLE 2

| | Protease Stability | | Amylase Stability | |
|---|---|---|---|---|
| Formula | 2 weeks | 4 weeks | 2 weeks | 4 weeks |
| B (comparative) | 62% | 44% | 55% | 36% |
| 1 (inventive) | 65% | 48% | 61% | 42% |
| 2 (inventive) | 65% | 50% | 59% | 40% |
| 3 (inventive) | 58% | 40% | 50% | 31% |

### Example 2

Stain performance testing was performed in a High Efficiency Toploader machine using a 1.78 fl oz (about 52.6 ml) dose per wash. The tested formulations are set forth in Table 3. “Fresh” was defined as being aged at about 4.4° C. (about 40° F.) for 2 weeks, whereas “Aged” was defined as being aged at 37° C. (about 98.6° F.) for 2 weeks.

TABLE 3

| Formula | Fresh | Aged |
|---|---|---|
| A (comparative) | X | N/A |
| B (comparative) | X | X |
| 1 (inventive) | X | X |
| 2 (inventive) | X | X |
| 3 (inventive) | X | — |

N/A: only a fresh sample was tested, since aging should not change performance as no enzymes were present in the formula

At 59° F. (15° C.) washing, each of Formulas 1-3 (fresh and aged) containing amino acids was statistically superior on cleaning certain stains, such as blood stains and BBQ sauce, on knitted cotton when compared against the fresh enzyme sample of Formula B that did not contain amino acids.

At 59° F. (15° C.) washing, both fresh and aged samples of Formula 2 were statistically superior for cleaning certain stains, such as dust sebum, on polyester fabric. The fresh sample of Formula 2 was statistically superior for clearing certain stains, such as burnt butter and grass, on knitted cotton.

At 90° F. (32° C.) washing, each of Formulas 1-3 (fresh and aged) containing amino acids was statistically superior on cleaning certain stains, such as BBQ sauce, on knitted cotton when compared against the fresh enzyme sample of Formula B that did not contain amino acids.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A detergent composition comprising water, at least one surfactant, at least one amino acid or a salt thereof, and at least one enzyme, wherein the detergent composition has a pH of about 10 to about 12.

2. The detergent composition of claim 1, wherein the at least one amino acid is selected from alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, any salt thereof, and any combination thereof.

3. The detergent composition of claim 2, wherein the at least one amino acid has a charged side chain or a polar uncharged side chain.

4. The detergent composition of claim 3, wherein the at least one amino acid is lysine, threonine, arginine, any salt thereof, or any combination thereof including salts thereof.

5. The detergent composition of claim 1, wherein the at least one surfactant is an anionic surfactant, a cationic surfactant, a zwitterionic surfactant, a nonionic surfactant, or any combination thereof.

6. The detergent composition of claim 5, wherein
the anionic surfactant comprises an alkyl sulfate, an alkyl sulfonate, a fatty acid salt, a bile acid salt, a glutamic acid salt, a cholic acid salt, a carboxylic poly(ethylene glycol) ether, a taurate, or any combination thereof;
the cationic surfactant comprises a fatty amine salt, a fatty diamine salt, a coco amine alkoxylate, an alkoxylated amine, an alkoxylated diamine, fatty quaternary ammonium compound, a fatty amide quaternary ammonium compound, an alkoxylated quaternary ammonium compound, a benzalkyl quaternary ammonium compound, or any combination thereof;
the zwitterionic surfactant comprises a betaine, a sulfonated quaternary ammonium compound, a phosphonated quaternary ammonium compound, a trialkylamine N-oxide, or any combination thereof; and
the nonionic surfactant comprises an alcohol alkoxylate, a fatty acid alkoxylate, an alkyl phenol ethoxylate, an alkoxylated amine, an alkyl glucoside, a fatty amide alkoxylate, a diester of alkoxylated fatty acid, an alkoxylated methyl ester of fatty acid, a glycerol fatty ester, castor oil alkoxylate, an ethylene oxide-propylene oxide block copolymer, a phenol alkoxylate, or any combination thereof.

7. The detergent composition of claim 6, wherein detergent composition comprises an alcohol ethoxylate, an alkylether sulfate, a coconut fatty acid, or any combination thereof.

8. The detergent composition of claim 1, wherein the at least one enzyme comprises a protease, an amylase, a mannanase, a lactase, a lipase, a perhydrolase, an oxidoreductase, an endocellulase, an exocellulase, or any combination thereof.

9. The detergent composition of claim 8, wherein the at least one enzyme comprises a protease, an amylase, a mannanase, or any combination thereof.

10. The detergent composition of claim 1, wherein the detergent composition has a pH of about 10.5 to about 11.

11. The detergent composition of claim 1, wherein the detergent composition further comprises a base.

12. The detergent composition of claim 11, wherein the base is a hydroxide, a tetraborate, a phosphate, a carbonate, a bicarbonate, or any combination thereof.

13. The detergent composition of claim 1, wherein the detergent composition further comprises at least one additive selected from a performance polymer, an anti-redeposition agent, a defoamer, a chelating agent, a biocide, and any combination thereof.

14. The detergent composition of claim 13, wherein the performance polymer comprises polyethyleneimine ethoxylate, polyethyleneimine ethoxylate propoxylate, or any combination of both.

15. The detergent composition of claim 13, wherein the anti-redeposition agent is based on acrylic acid.

16. The detergent composition of claim 1, wherein the detergent composition comprises about 55 to about 75 wt % water,
about 15 to about 30 wt % of at least one surfactant,
about 0.25 to about 2 wt % of at least one amino acid or a salt thereof, and
about 0.05 to about 3 wt % of at least one enzyme.

17. The detergent composition of claim 1, wherein the detergent composition comprises at least one anionic surfactant, at least one nonionic surfactant, a base, a biocide, a performance polymer, an antiredeposition agent, and a chelating agent.

18. The detergent composition of claim 17, wherein the detergent composition comprises
at least one surfactant selected from an alkylether sulfate, an alcohol ethoxylate, and
coconut fatty acid,
at least one amino acid selected from lysine, arginine, or a salt thereof, and
a base comprising a hydroxide and a carbonate.

19. The detergent composition of claim 1, wherein the detergent composition scavenges chlorine to a concentration of 0 ppm in less than about 120 sec after contact with a 1 L water sample comprising up to 4 ppm chlorine.
